(19) United States
(12) Patent Application Publication
(10) Pub. No.: US 2011/0128543 A1
(43) Pub. Date: Jun. 2, 2011

(54) RAIN SENSOR USING LIGHT SCATTERING

(75) Inventor: Kyoo Nam CHOI, Bucheon (KR)

(73) Assignee: DONGYANG MECHATRONICS CORP., Incheon (KR)

(21) Appl. No.: 12/630,850

(22) Filed: Dec. 4, 2009

(30) Foreign Application Priority Data
Nov. 30, 2009 (KR) 10-2009-0117094

(51) Int. Cl. G01N 21/47

(52) U.S. Cl. 356/342

(57) ABSTRACT

A rain sensor using light scattering, and more particularly to, a rain sensor for detecting an amount of moisture particles, such as raindrops or fog, accumulated in a front windshield of a vehicle, and applying the amount of moisture particles to an operation of a wiper of the vehicle.

### CROSS-REFERENCE TO RELATED PATENT APPLICATIONS

This application claims the benefit of Korean Patent Application No. 10-2009-0117094, filed on Nov. 30, 2009, in the Korean Intellectual Property Office, the disclosure of which is incorporated herein in its entirety by reference.

### BACKGROUND OF THE INVENTION

1. Field of the Invention

The present invention relates to a rain sensor using light scattering, and more particularly to, a rain sensor for detecting an amount of moisture particles, such as raindrops or fog, accumulated in a front windshield of a vehicle, and applying the amount of moisture particles to an operation of a wiper of the vehicle.

2. Description of the Related Art

If moisture is accumulated in a transparent material, such as glass or plexiglass, the transparent material may prevent a persons' field of vision. A vehicle is equipped with a motor drive type windshield wiper used to remove moisture from a wider area of the external surface of a windshield within a range of a driver's field of vision so as to improve the field of vision through the windshield.

Although most vehicles are not equipped with unlimitedly various windshield wipers, vehicles include a multi-switch or a variable speed switch that allows a driver to select a wide range of speeds according to the circumstances.

A wiper is manually controlled and exhibits typical delay characteristics so that the wiper inadvertently operates at a selected time delay interval.

A recently developed wiper control system includes a moisture sensor or a rain sensor that is installed in one of vehicle windows and automatically operates a wiper motor when moisture is formed on the surface of a window.

Although the wiper control system including the moisture sensor or the rain sensor is generally installed in a windshield, it may be installed in a rear window or in another glass surface intended to remove moisture.

A driver does not need to frequently adjust a wiper speed according to a change in the driving conditions using the wiper control system.

The wiper control system includes conductivity, electrical capacity, and piezoelectric and light sensors, and uses a plurality of different technologies for detecting a moisture status that occurs in a vehicle.

If moisture is accumulated in the external surface of a windshield, the light sensor operates based on a principle that a light beam is scattered by being deflected from a normal path.

Although various methods has been proposed for a rain sensor, electronic methods, other than a optoelectronic method, are not generally used due to reliability that falls short of obtaining an electrical output in proportional to the size of large or small water particles. Most vehicles currently use the optoelectronic method.

FIG. 1 is a conceptual diagram of a conventional optical waveguide type rain sensor. Referring to FIG. 1, if light radiated from a light source 100 is collected to be askew incident onto a glass window 140 having a specific thickness or a windshield, an optical waveguide is formed in the glass window 140 within a specific angle range to transfer light.

In this regard, if rain drops or water drops 130 fall down on the glass plate 140, since the inner guiding conditions of the optical waveguide are broken, the light is leaked to the outside, and thus an amount of light received by a light receiving element 120 changes, which is used as a parameter for determining the size of raindrops.

The optical waveguide type rain sensor needs complicated geometrical optical systems shown in FIG. 3 in order to form guiding condition inside waveguide.

The optical waveguide type rain sensor needs optical systems, such as input lenses 350a and 350b of FIG. 3, between the light source 100 and the glass window 140 in order to collect the light radiated from the light source 110 and make the light incident onto the windshield, and necessarily needs output lenses 360a and 360b to transfer guiding light output from the glass window 140 to the light receiving element 120, which makes the structure of the optical waveguide type rain sensor complicated.

FIG. 2 is a conceptual diagram of a conventional direct reflective type rain sensor. Referring to FIG. 2, light radiated from a light source 210 is collected to be irradiated onto a specific part of the surface of a glass window 240 in order to measure an amount of light directly reflected by raindrops. If water drops or raindrops 230 fall down on the specific part of the surface of the glass window 240, the amount of reflected light changes, which is detected in a light receiving element 220.

The conventional direct reflective type rain sensor needs complex geometrical optical systems, such as the input lenses 350a and 350b and the output lenses 360a and 360b, in order to transfer most of light radiated from the light source 210 to the light receiving element 220.

The conventional direct reflective type rain sensor collects the light radiated from the light source 210 and measures the amount of light reflected from a specific point, which reduces a detection range of the raindrops 230.

FIGS. 3A and 3B illustrate geometrical optical systems of a conventional rain sensor. Referring to FIGS. 3A and 3B, the geometrical optical systems of the conventional rain sensor increase an area for detecting raindrops and maintain a limited number of light source 310 and light receiving elements 320.

When the light source 310 is driven by a discharge driving circuit, the light source 310 emits light having predetermined characteristics.

Light is radiated from the light source 310 and is incident onto the surface of input side planoconvex les segments 350a and 350b.

Light that moves within an irradiation angle θ11 is incident onto the surface of the input side planoconvex les segments 350a and 350b.

The light emitted by the light source 310 is refractive to form an input side collimated light beam through the surface of the input side planoconvex lens segments 350a and 350b.

The input side collimated light beam moves toward a front glass 340 through a light guide body 370.

The input side collimated light beam collimated by the input lens 350 is applied to an external wall surface 380a from an internal wall surface 380b. The input side collimated light beam of the external wall surface 380a is applied to a raindrop detection area.

The input side collimated light beam is reflected from the external wall surface 380a of the raindrop detection area. Thereafter, the reflected light moves forward output side planoconvex les segments 360a and 360b through the light guide body 370, as a reflected collimated light beam.

The reflected collimated light beam is incident onto the output side planoconvex les segments 360a and 360b and is refractive from the surface of the output side planoconvex les segments 360a and 360b to be converged forward the light receiving element 320.

The light receiving element 320 receives light that moves within a light receiving angle θ21.

An optical path of the light emitted by the light source 310 is formed as follows.

The input side planoconvex les segments 350a and 350b obtained by dividing a planoconvex lens into two lens segments are formed on corresponding output side inclination planes 395a and 395b.

A single optical axis is formed on an input side image and another single optical axis is formed on an output side image, thereby reducing the number of light sources and light receiving elements necessary for a rain sensor.

### SUMMARY OF THE INVENTION

The present invention provides a rain sensor using light scattering in order to simplify a complicated structure of a conventional light waveguide type rain sensor or a conventional direct reflective type rain sensor that has a narrow detection range and needs geometrical optical system

According to an aspect of the present invention, there is provided a rain sensor using light scattering including: a light receiving element for receiving light that is radiated from a light source, penetrates through a windshield, and is scattered in water drops; and a light blocking material for blocking the radiated light that is directly reflected from the windshield.

The light receiving element may be attached to the windshield, and the light source may maintain a reference distance from the windshield.

The light blocking material may seal the light receiving element except for a surface of the light receiving element attached to the windshield.

A reference distance between the light source and the light receiving element may be maintained in order to reduce an amount of the radiated light that is guided inside the windshield and is received by the light receiving element.

The light source may be a light emitting diode (LED) having a center wavelength within an infrared ray region.

The light source may maintain a reference incidence angle and a horizontal distance from the light blocking material.

The light source may further include an oscillator that oscillates a sine wave and a modulator that modulates a light source according to an oscillation signal of the oscillator.

The light source may further include an amplifier that amplifies a photoelectrically converted signal and a band pass filter that filters the same frequency component as an oscillation frequency of the oscillator.

The light blocking material may be a totally opaque material with respect to the radiated light, except the scattered light.

### BRIEF DESCRIPTION OF THE DRAWINGS

The above and other features and advantages of the present invention will become more apparent by describing in detail exemplary embodiments thereof with reference to the attached drawings in which:

FIG. 1 is a conceptual diagram of a conventional optical waveguide type rain sensor;

FIG. 2 is a conceptual diagram of a conventional direct reflective type rain sensor;

FIGS. 3A and 3B illustrate geometrical optical systems of a conventional rain sensor;

FIG. 4 is a diagram of a structure of a rain sensor according to an embodiment of the present invention;

FIG. 5 is a diagram for explaining a total reflection in a windshield of a rain sensor according to an embodiment of the present invention;

FIG. 6 is a diagram of a reference distance between a light source and a light receiving element according to an embodiment of the present invention; and

FIG. 7 is a diagram for explaining the operation of a rain sensor according to an embodiment of the present invention.

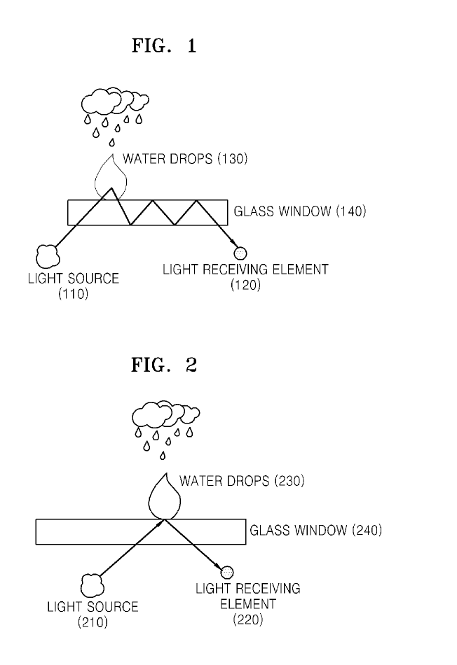

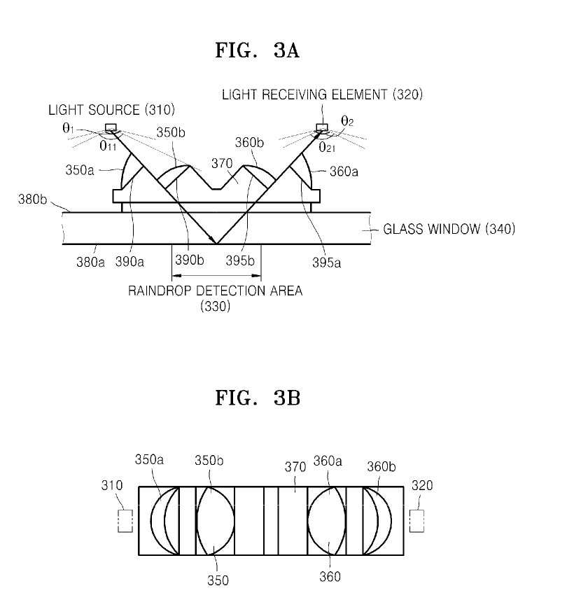

### DETAILED DESCRIPTION OF THE INVENTION

Hereinafter, the present invention will be described in detail by explaining exemplary embodiments of the invention with reference to the attached drawings.

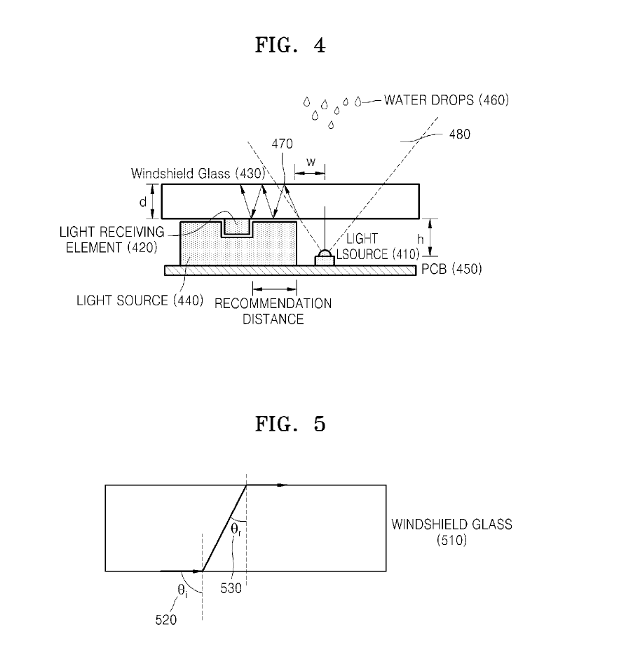

FIG. 4 is a diagram of a structure of a rain sensor according to an embodiment of the present invention. Referring to FIG. 4, the rain sensor of the present embodiment uses light scattering and does not need a geometrical optical system, unlike the conventional rain sensor.

The rain sensor of the present embodiment includes a light source 410, a light receiving element 420, and a light blocking material 440 for preventing light directly reflected from a windshield 430 or light directly output from the light source 410 from being received.

The light reflected from the light source 410 spreads over the entire area of a radiation angle 480 and thus a raindrop detection area of the rain sensor of the present embodiment is much wider than the conventional rain sensor.

The light reflected from the light source 410 scatters in water drops or raindrops 460 through the windshield 430. The light receiving element 420 receives the scattered light.

The more the number of water drops, the greater the amount of scattered light received by the light receiving element 420.

The light receiving element 420 is disposed to contact the windshield 430 in order to prevent the light receiving element 420 from receiving the light that is radiated from the light source 410 and is directly reflected from the windshield 430, and the light receiving element 420 is sealed by using the light blocking material 440 in order to prevent the light directly output from the light source 410 from being received in the light receiving element 420.

The light source 410 is a light emitting diode (LED) having a center wavelength within an infrared ray region. The light blocking material 440 is a totally opaque material in order to block the light directly reflected from the windshield 430 or the light directly radiated from the light source, except the light scattered against the water drops.

The light source 410 is spaced apart from the windshield 430 by a distance h so that the light source 410 is disposed farther from the windshield 430 than the light receiving element 420.

The light receiving element 420 and the light source 410 are spaced apart from each other by a recommendation distance in order to receive the minimum amount of the light that is radiated from the light source 410 and is guided in the windshield 430.

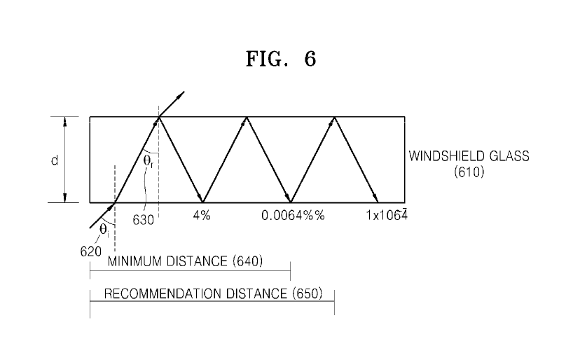

The recommendation distance between the light source 410 and the light receiving element 420, a horizontal distance w between the light source 410 and the light blocking material 440, and a distance h between the light source 410 and the windshield 430 will now be described in more detail with reference to FIGS. 5 and 6.

FIG. 5 is a diagram for explaining a total reflection in a windshield 510 of a rain sensor according to an embodiment of the present invention. Referring to FIG. 5, the light reflected from the light source 410 is incident in a predetermined incidence angle 520. An inside reflection angle 530 by which the incident light is not guided inside the windshield 510 and penetrates through the windshield 510 is calculated according to an equation below,

n_{1*}sin θ=n₂*sin θ

sin 90°=1.5*sin θᵣ

θᵣ=41.8° 1)

wherein, a refractive index n₁ of air is 1, and a refractive index n₂ of a windshield is 1.5.

In more detail, the maximum value of the inside reflection angle 530 by which the incident light is not guided inside the windshield 510 and penetrates through the windshield 510 is 41.8 according to the Snell's law of equation 1 above.

The predetermined incidence angle 520 by which the light radiated from the light source 410 is incident must be smaller than the inside reflection angle 530 by which the incident light is not guided inside the windshield 510 and penetrates through the windshield 510.

When the inside reflection angle 530 is smaller than 41.8, a part of the incident light penetrates through the windshield 510 and a part thereof is guided inside the windshield 510.

If the light receiving element 420 receives the light guided to the windshield 510, the rain sensor malfunctions.

In more detail, if the light receiving element 420 receives the light directly reflected from the windshield 510 or the light guided inside the windshield 510, except the light scattered against the water drops 460, an error with the water drops detection result occurs.

Thus, the light source 410 and the light receiving element 420 must maintain the minimum distance therebetween in order to minimize the amount of guided light received by the light receiving element 420.

The minimum distance between the light source 410 and the light receiving element 420 is shown in FIG. 6.

FIG. 6 is a diagram of a reference distance between the light source 410 and the light receiving element 420 according to an embodiment of the present invention. Referring to FIG. 6, when the inside reflection angle 630 is smaller than 41.8, a part of the incident light penetrates through a windshield 610 and a part thereof is guided inside the windshield 610.

Power of the light guided inside the windshield 610 is calculated according to an equation below,

$${P}_{r}^{1 st} = {\vert {E}_{r} \vert}^{2} = {\vert \frac{{n}_{1} - {n}_{2}}{{n}_{1} + {n}_{2}} \vert}^{2} = {\vert \frac{1 - 1.5}{1 + 1.5} \vert}^{2} = 4 \% \\ {P}_{r}^{3 rd} = {( 4 * {10}^{- 2} )}^{3} = 6.4 * {10}^{- 5} = 0.0064 \% \\ {P}_{r}^{5 th} = {( 4 * {10}^{- 2} )}^{5} = 1 * {10}^{- 7} \qquad 2 )$$

wherein, a refractive index n1 of air is 1, and a refractive index n2 of a windshield is 1.5.

The power of the light guided inside the windshield 610 is 4% in a first reflection, 0.0064% in a third reflection, and 1*10̂−7% in a fifth reflection as shown in equation 2 above and FIG. 6.

Thus, the light source 410 and the light receiving element 420 must maintain a recommendation distance 650 in order to receive the guided light in the light receiving element 420 through the fifth reflection.

The rain sensor of the present embodiment has a structure in which the light receiving element 420 is disposed to contact the windshield 610 and the light receiving element 420 is sealed by using the light blocking material 440 in order to reduce the influence of the light directly reflected from the windshield 610 and the light source 410 and the light receiving element 420 are spaced apart from each other by the recommendation distance 650 in order to reduce the influence of the light guided inside the windshield 610 as shown in FIG. 6.

Table 1 below shows recommendation distances between the light source 410 and the light receiving element 420 when the inside reflection angle 630 is smaller than 41.8.

TABLE 1

| | | | | Pᵣ (power | |
|---|---|---|---|---|---|
| | θₗ (external | θᵣ (internal | l (minimum | of reflected | recommendation |
| case | incidence angle) | incidence angle) | distance) | light) | distance |
| 1 | 90° | 41.8° | 3.56d | 1 × 10⁻⁷ Pᵢ | 27 mm |
| 2 | 48.6° | 30° | 2.32d | 1 × 10⁻⁷ Pᵢ | 18 mm |
| 3 | 32.3° | 20.9° | 1.53d | 1 × 10⁻⁷ Pᵢ | 12 mm |
| 4 | 22.8° | 15° | 1.07d | 1 × 10⁻⁷ Pᵢ | 8 mm |
| 5 | 10° | 6.7° | 0.47d | 1 × 10⁻⁷ Pᵢ | 4 mm |

In Table 1 above, d denotes a thickness of the windshield 610 and d=6 mm.

In Table 1 above, a recommendation distance is based on an arrival distance of a guided light in the fifth reflection.

In the rain sensor of the present embodiment, since an external incidence angle 620 is a main factor for determining the recommendation distance, the horizontal distance w between the light source 410 and the light blocking material 440 and the distance h between the light source 410 and the windshield 430 are calculated in Table 2 below.

TABLE 2

| | | |
|---|---|---|
| θᵢ = 10° | θᵢ = 32.3° | θᵢ = 48.6° |

| h | w | h | w | h | w |
|---|---|---|---|---|---|
| 4 mm | 0.7 mm | 4 mm | 2.5 mm | 4 mm | 4.6 mm |
| 5 mm | 0.9 mm | 5 mm | 3.2 mm | 5 mm | 5.7 mm |
| 6 mm | 1.1 mm | 6 mm | 3.8 mm | 6 mm | 6.8 mm |

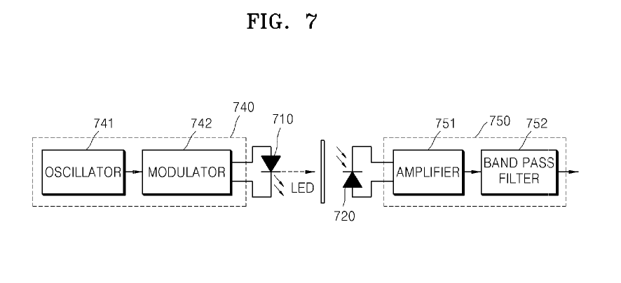

FIG. 7 is a diagram for explaining the operation of a rain sensor according to an embodiment of the present invention. Referring to FIG. 7, an oscillator 741 oscillates a sine wave between 40 kHz and 60 kHz.

A modulator 742 modulates a light source 710 according to an oscillation signal of the oscillator 741.

Light radiated from the light source 710 is scattered in water drops or raindrops through a windshield. A light receiving element 720 receives the scattered light.

The light receiving element 720 photoelectrically converts the received light.

An amplifier 751 amplifies a photoelectrically converted signal. A band pass filter 752 filters the same frequency component as an oscillation frequency of the oscillator 741.

The rain sensor using light scattering of the present invention does not collimate light radiated from a light source and radiates light onto a wide area, requiring no complicated geometrical optical system and recognizing raindrops on a relatively wide 2D plane.

The rain sensor using light scattering of the present invention can simplify a complicated structure of the conventional direct reflective type and light waveguide type rain sensors that detect raindrops contacting the surface of glass and need optical systems for collimating radiated light in a beam format and an optical system for collimating reflected or guided light into a light receiving element again.

The rain sensor using light scattering of the present invention needs no complicated optical system and uses a wide raindrop detection area, unlike the conventional direct reflective type rain sensor or the conventional light waveguide type rain sensor.

The rain sensor using light scattering of the present invention solves interference of light that is radiated from a light source and is directly reflected from a windshield or guided in the windshield by means of a relative arrangement of light receiving elements, thereby simplifying the structure thereof and achieving an excellent raindrop detection performance.

While this invention has been particularly shown and described with reference to exemplary embodiments thereof, it will be understood by those of ordinary skill in the art that various changes in form and details may be made therein without departing from the spirit and scope of the invention as defined by the appended claims.

What is claimed is:

1. A rain sensor using light scattering comprising:
a light receiving element for receiving light that is radiated from a light source, penetrates through a windshield, and is scattered in water drops; and
a light blocking material for blocking the radiated light that is directly reflected from the windshield.

2. The rain sensor of claim 1, wherein the light receiving element is attached to the windshield, and the light source maintains a reference distance from the windshield.

3. The rain sensor of claim 2, wherein the light blocking material seals the light receiving element except for a surface of the light receiving element attached to the windshield.

4. The rain sensor of claim 1, wherein a reference distance between the light source and the light receiving element is maintained in order to reduce an amount of the radiated light that is guided inside the windshield and is received by the light receiving element.

5. The rain sensor of claim 1, wherein the light source is a light emitting diode (LED) having a center wavelength within an infrared ray region.

6. The rain sensor of claim 3, wherein the light source maintains a reference incidence angle and a horizontal distance from the light blocking material.

7. The rain sensor of claim 1, wherein the light blocking material is a totally opaque material with respect to the radiated light, except the scattered light.
